(19) United States
(12) Patent Application Publication
(10) Pub. No.: US 2022/0394823 A1
(43) Pub. Date: Dec. 8, 2022

(54) ELECTRICAL HEATING DEVICE, IN PARTICULAR FOR MOBILE APPLICATIONS

(71) Applicant: Webasto SE, Stockdorf (DE)

(72) Inventors: STEPHAN BUCKL, Stockdorf (DE); ANDREAS SCHMIDMAYER, Stockdorf (DE); FLORIAN LARISCH, Stockdorf (DE)

(21) Appl. No.: 17/770,568

(22) PCT Filed: Oct. 20, 2020
(86) PCT No.: PCT/EP2020/079472

§ 371 Date: Apr. 20, 2022

(30) Foreign Application Priority Data
Oct. 22, 2019 (DE) 10 2019 128 467.8

(51) Int. Cl. H05B 3/26

(52) U.S. Cl. CPC H05B 3/262

(57) ABSTRACT

An electric heating device, in particular for mobile applications, having a substrate and a heat conductor layer formed on the substrate. The heat conductor layer is interrupted by at least a first isolating interruption, the first isolating interruption separating at least a first and a second layer portion of the heat conductor layer from one another. The first layer portion is connected at a first end to a first terminal, for example positive pole, and the second layer portion is connected at a first end to a second terminal, for example negative pole. The first layer portion is connected at a second end to the second layer portion and is connected via this second layer portion to the second terminal.

This application represents the national stage entry of PCT International Patent Application No. PCT/EP2020/079472 filed on Oct. 20, 2020 and claims priority to German Patent Application No. 10 2019 128 467.8 filed on Oct. 22, 2019. The contents of each of these applications are hereby incorporated by reference as if set forth in their entirety herein.

### DESCRIPTION

The disclosure relates to an electric heating device for mobile applications according to claim 1 and to a vehicle, in particular a motor vehicle, comprising an electric heating device.

WO 2013/186106 A1 describes an electric heating device for a motor vehicle with a heating resistor formed as a conductor track on a substrate. The conductor track is bifilar and a widened insulation region is provided in the region of a conductor track deflection in the opposite direction. The widened insulation region is intended to ensure that current flows through the full width of the conductor track as far as possible, in order to avoid the formation of regions with particularly good flow internally and regions with poor flow in the outer edge region of the conductor track. In this context, however, it has been found that a comparatively high temperature can still occur in the region of the conductor track deflection.

It is the object of the present disclosure to propose an electric heating device as well as a corresponding vehicle, in particular motor vehicle, in which a comparatively homogeneous temperature distribution is achieved, wherein the electric heating device is to be as compact and inexpensive to manufacture as possible.

This object is achieved by an electric heating device, in particular for mobile applications, according to claim 1.

In particular, the object is achieved by an electric heating device, in particular for mobile applications, preferably for a vehicle, in particular motor vehicle, with: a substrate (in particular electrically insulating and/or electrically insulated at least with respect to the heat conductor layer) and an (electrically conductive) heat conductor layer formed on the substrate (in particular in a main plane), wherein the heat conductor layer is interrupted (in particular completely) by at least a first isolating interruption, wherein the first isolating interruption separates at least a first (electrically conductive) and a second (electrically conductive; in particular running adjacently, preferably at least at substantially the same height relative to the substrate) layer portion of the heat conductor layer from one another, wherein the first layer portion is connected (electrically conductively) at a first end to a first (electrical) terminal or pole, for example a positive pole, and the second layer portion is connected (electrically conductively) at a first end to a second (electrical) terminal or pole, for example negative pole, wherein the first layer portion is connected at a second end to the second layer portion (possibly via a connecting portion, in particular connecting strip) and is connected (at least, possibly only) via this second layer portion to the second terminal or pole. Accordingly, the second layer portion is preferably connected to the first terminal or pole (at least, possibly only) via the first layer portion.

A core concept of the disclosure is to separate at least two layer portions of a heat conductor layer from each other by means of a (first) isolating interruption and to interconnect or electrically connect (contact) them accordingly in such a way that a current flows via the at least two layer portions (in particular serially) and heating can take place. The manufacturing and in particular structuring effort can be comparatively low here. The temperature (in operation) in the region of deflections can be comparatively moderate or not significantly increased (compared to other regions). Overall, an effective and reliably operating heating device is achieved in a simple manner.

An isolating interruption means in particular an interruption that prevents or at least reduces the flow of current (directly or via the isolating interruption) between corresponding regions or portions that are separated from each other. For this purpose, the isolating interruption is preferably insulating or has a suitably high resistance.

An electrical conductivity of the (particular) isolating interruption is preferably less than 10⁶S·m⁻¹, further preferably less than 10³ S·m⁻¹, further preferably less than 10⁻¹ S·m⁻¹, further preferably less than 10⁻⁴ S·m⁻¹, further preferably less than 10⁻⁶ S·m⁻¹ (at 20° C.).

Alternatively or additionally, an electrical conductivity of the (particular) isolating interruption is preferably lower than an electrical conductivity of the relevant portions separated from each other, in particular multiplied by the factor 0.5; preferably multiplied by the factor 0.1, further preferably multiplied by the factor 0.05, (at 20° C.).

Alternatively or additionally, an electrical conductivity of the (particular) isolating interruption is preferably lower than an electrical conductivity of an/the electrical connecting portion, in particular connecting strip, e.g. copper strip, in particular multiplied by the factor 0.5; preferably multiplied by the factor 0.1, further preferably multiplied by the factor 0.05, (at 20° C.).

Preferably, the heat conductor layer is interrupted (in particular completely) by at least a second isolating interruption, wherein the second isolating interruption separates at least a third layer portion from at least a second layer portion of the heat conductor layer. Further preferably, the third portion is connected (electrically conductively) at a first end to the first terminal or pole, for example positive pole. Overall, a particularly effective and yet simple structuring can thus be achieved.

The third layer portion is preferably connected to the second terminal (only) via the second layer portion.

Insofar reference is made to connections in this document, electrically conductive connections are always meant, unless the context indicates otherwise.

In a specific embodiment, there are exactly two isolating interruptions, but there can also be at least three or at least four isolating interruptions. In this respect, the heat conductor layer can be divided, according to the embodiment, into exactly two or three layer portions, but if necessary also into more than three, in particular into more than four or more than five layer portions (by corresponding isolating interruptions).

According to the embodiment, the first and second layer portions are (at least partially) connected (conductively) to each other by an additional or separate conductor, in particular a wire and/or a conductive (according to the embodiment unstructured) strip (metal strip), wherein the strip can alternatively also be structured. A separate conductor means in particular a conductor which is structurally separated from the heat conductor layer, in particular is (additionally) attached to and/or on the heat conductor layer and/or has an increased (or reduced) thickness compared to the heat conductor layer. A metal strip is particularly preferred, further preferably a copper strip (i.e. a metal strip made of copper or a copper alloy). The separate conductor (in particular strip) may extend over at least 50%, possibly at least 80% or (at least nearly) 100% of one side of the (entire) heat conductor layer (or even beyond this side). A width of the separate conductor (in particular strip) preferably corresponds to at most 50%, further preferably at most 10% of an extension of the heat conductor layer in the direction of the width of the separate conductor (strip). In specific embodiments, the separate conductor (in particular strip) is at least 3 times, preferably at least 5 times as long as it is wide. The separate conductor (in particular strip) can have (at least substantially) a rectangular contour and/or two (in particular parallel) longitudinal sides extending over at least 50% of the total length of the strip.

In embodiments, the first and second terminal or pole are (at least partially) associated with a second (separate) conductor, in particular a (second) wire and/or a (second) conductive strip, in particular a common strip and/or a strip divided into at least two separate strip portions by at least one terminal isolating interruption.

In embodiments, the second separate conductor may have a contour line like the first separate conductor. Preferably, the second separate conductor differs from the first separate conductor (at least or even only) in that the second separate conductor comprises at least one terminal isolating interruption (which divides it into at least two electrically separated strip portions).

The second separate conductor can have (apart from the terminal isolating interruption(s)) a geometry or structure as described with respect to the first separate conductor (even if the first separate conductor is not formed according to such geometry or has an alternative geometry). Also with regard to the choice of material, reference is made to the first separate conductor with regard to the second separate conductor (even if the former does not have the above optionally proposed choice of material). Overall, the second separate conductor provides a terminal for the individual layer portions in a simple manner.

In a preferred embodiment, at least one terminal isolating interruption merges into and/or is aligned with and/or is arranged on the same line as at least one isolating interruption (of the heat conductor layer). In a specific embodiment, each isolating interruption (of the heat conductor) may be associated with a corresponding terminal isolating interruption of the second separate conductor (strip).

In a preferred embodiment, the first and second terminal (pole) are arranged on the same side of the heat conductor layer. A side of the heat conductor layer means in particular an edge side (i.e. in particular not a top side or bottom side, but in particular an edge side in a view from above (plan view)). The edge side can be one (or possibly two) shorter sides (alternatively one of possibly two longer sides).

In a specific embodiment, first and second separate conductors can be arranged on opposite sides (in the sense of the previous paragraph).

According to the embodiment, at least one isolating interruption runs at least substantially straight. An at least substantially straight course it is to be understood in particular to mean that the isolating interruption runs either over its entire length in the same direction or possibly in directions (at least slightly) deviating from each other, wherein, however, a maximum deviation (among all pairs of local directions) is preferably not greater than 45°, preferably not greater than 20°, further preferably not greater than 10°. In particular, a direction of the isolating interruption (with respect to its course) should not at any point be 180° with respect to at least one other point (or the direction there). In this way, structuring can be carried out in a simple manner.

In preferred embodiments, the heat conductor layer and/or the first and/or the second and/or the third layer portion is/are at least substantially rectangular. Alternative geometries are conceivable (for example circular, elliptical or generally polygonal).

Preferably, the heat conductor layer covers at least 80% of a substrate surface, further preferably at least 85% of the substrate surface. In this case, a comparatively good utilisation of the available substrate surface is given and a sufficient separation of the individual track portions from each other is still possible. In particular, the heat conductor layer can cover less than 95% of the substrate surface.

An electrically insulating material can be arranged in the isolating interruptions. Alternatively or additionally, the isolating interruptions can also be formed by (for example, gap-like) free spaces.

At least one further layer, in particular an insulating layer, can be formed on the heat conductor layer.

In embodiments, the second layer portion is wider than the first and/or third layer portion, preferably at least 1.2 times as wide, further preferably at least 1.5 times as wide. This is particularly advantageous if the second layer portion is formed as a common conductive layer portion for two heating circuits (separated from each other, for example, in a first layer portion and a third layer portion).

At least two of the present (in particular the first and the second), possibly all of the present (in particular the first, second and third), layer portions can be arranged in one plane, in particular on a common planar surface. Alternatively or additionally, at least two of the present (in particular the first and the second), possibly all of the present (in particular the first, second and third), layer portions may not be arranged in one plane, for example on a non-planar surface and/or in different planes (if, for example, four or six layer portions are provided, of which each two or respectively each three are arranged on different planes, in particular on different substrates).

In general, two or more heating circuits are preferably formed. The individual heating circuits should preferably differ in that they have at least one layer portion (for example a first layer portion) which is not associated with at least one further heating circuit. However, this is not intended to exclude the possibility that a further layer portion (for example the second layer portion) is contained jointly in two heating circuits. In a specific embodiment, the electric heating device comprises at least two heating circuits, wherein the first layer portion is only associated with the first heating circuit, the third layer portion is only associated with the second heating circuit and the second layer portion is associated with both heating circuits. A heating circuit means in particular an electrical circuit extending from a first terminal (pole) to a second terminal (pole).

At least one isolating interruption preferably runs through the heat conductor layer from a first to a second side (edge side) thereof, in particular completely. The sides (edge sides) are preferably opposite (edge) sides.

In a specific embodiment, the electric heating device is a motor vehicle heating device.

The above-mentioned object is further achieved in particular by a vehicle, in particular motor vehicle, comprising an electric heating device of the above type.

The above-mentioned object is in particular further achieved by a method for (the) manufacture of the above electric heating device.

Preferably, at least one isolating interruption is produced by laser structuring. Alternatively or additionally, at least one isolating interruption can be produced by masking at least one masking portion (when applying the heating layer).

In a specific embodiment of the method, at least one isolating interruption can alternatively or additionally be produced by an elongate body, in particular wire, which is inserted during production (and later removed again).

Generally, the heating layer can be applied by thermal spraying.

At least one contact pad, in particular comprising copper, can be provided for electrical contacting, for example one contact pad per layer portion. A contact pad is preferably a contact portion, for example round and/or oval (in particular elliptical), which is preferably applied from the liquid state, for example by dripping (soldering).

A terminal strip, preferably comprising copper, and/or at least one connecting strip, preferably comprising copper, can be thermally sprayed.

At least one terminal strip, preferably comprising copper, and/or at least one connecting strip, preferably comprising copper, can be connected to at least one (the) contact pad, preferably comprising copper.

Overall, an electric heating device is proposed that in particular can effectively cover the increasing demand in electrically driven vehicles (due to their increasing prevalence). In the past, so-called PTC heating elements were predominantly used as electric heating devices for such mobile applications and were operated with comparatively low supply voltages that are present in an on-board power supply of a conventional motor vehicle with an internal combustion engine. Particularly in the case of modern vehicles that are fully or partially electrically driven, there is a need to be able to operate the vehicles electrically with the supply voltages that are present in a high-voltage on-board power supply provided in these vehicles, such as a voltage in a range between 150 volts and 900 volts, possibly even up to over 1,000 volts.

In the present context, a heating device for mobile applications is understood to be a heating device that is designed for use in mobile applications and adapted accordingly. This means in particular that it is transportable (possibly permanently installed in a vehicle or merely accommodated therein for transport) and is not designed exclusively for permanent, stationary use, as is the case, for example, with the heating system of a building. A weight of the heating device may be less than 500 kg, preferably less than 100 kg, still more preferably less than 20 kg. The heating device may possibly be permanently installed in a vehicle (land vehicle, ship, etc.), in particular in a land vehicle. In particular, it can be designed for heating a vehicle interior, such as a land, water or air vehicle, as well as a (partially) open space, as can be found on ships, in particular yachts. The heating device can also be used (temporarily) in a stationary manner, such as in large tents, containers (e.g. construction containers), etc. In particular, the electric heater can be designed for mobile applications as a parking heater or auxiliary heater for a land vehicle, such as a caravan, motor home, bus, passenger car, etc.

The substrate can have a planar or non-planar (for example, arched or curved) surface. The layer portions (possibly running adjacently) separated from each other by isolating interruptions are preferably arranged at a (at least substantially) uniform height relative to the substrate surface.

Preferably, an electrically insulating material is arranged in the isolating interruptions. The electrically insulating material can preferably also cover the surface of the heat conductor track or tracks facing away from the substrate in addition to the isolating interruptions. The electrically insulating material can in particular preferably be deposited as a layer after forming the heat conductor track or tracks. The electrically insulating material is preferably (comparatively well) electrically insulating on the one hand, but (comparatively well) thermally conductive on the other hand. Due to the electrically insulating material, the width of the isolating interruptions can be kept comparatively small, so that the available surface of the substrate can be efficiently utilized for the heat conductor track or tracks.

According to a further development, at least one additional layer is formed on the heat conductor layer. In particular, a plurality of layers can be formed on the heat conductor layer. Preferably, an insulating layer can be formed on the heat conductor layer and can also fill the isolating interruptions between the track portions of the heat conductor track. Preferably, a sensor layer for monitoring the function of the electric heating device can also be formed on the insulating layer. The insulating layer can provide a high degree of safety by additionally insulating current-conducting regions.

In a specific embodiment, the electric heating device is a motor vehicle heating device. The electric heating device can be designed in particular for heating a fluid, such as air for an interior of the vehicle or a liquid in a liquid circuit of the vehicle.

The above-mentioned object is further achieved in particular by the use of an electric heating device of the type described above for a vehicle, in particular motor vehicle.

The design of the electric heating device generally also has the advantage that no (or only little) additional space is required on the substrate surface, so that efficient use of the available space is made possible. Overall, a comparatively simple and cost-effective design is possible.

The heat conductor layer is preferably a layer deposited flat on the substrate and, if necessary, subsequently structured with material removal. This enables comparatively inexpensive manufacturing of the heat conductor track or the heat conductor tracks. The heat conductor layer can preferably be applied to the substrate by a thermal spraying process and then structured (e.g. by laser processing). In principle, however, other processes such as printing processes, casting processes or the like are also conceivable for forming the heat conductor layer. Likewise, other methods for structuring are possible, such as etching, mechanical removal, ultrasound or the like. The heat conductor layer is preferably made of an electrically conductive, in particular metallic, material. Furthermore, the heat conductor layer can be separated from the material of the substrate via an interposed, electrically insulating (and possibly effectively thermally conductive) intermediate layer. In particular, the heat conductor layer can, for example, be formed from a nickel-chromium alloy and/or can be separated from the material of the substrate via an aluminium oxide layer. The substrate can preferably have a comparatively good thermal conductivity, in particular can be made of a metal.

The heat conductor layer or the particular layer portion can preferably have a thickness (in the direction perpendicular to the substrate) in the range of 5 μm to 30 μm, in particular in the range of 10 μm to 25 μm.

A width (or extension perpendicular to a direction of current flow) of a (particular) layer portion can be at least 5 mm, preferably at least 25 mm and/or at most 500 mm, possibly at most 100 mm.

In a specific embodiment, the electric heating device is designed as a high-voltage heater for an operating voltage in the range of preferably between 150 volts and 900 volts, further preferably between 200 volts and 600 volts. However, a design up to over 1,000 volts may also be possible. In this case, the electric heating device can be used particularly advantageously, for example in an electric or hybrid vehicle (without necessarily requiring complex voltage converters).

Preferably, a HV+ and a HV− potential is separated by structuring (by means of isolating interruption(s)). A thin layer of copper (in particular thermally sprayed) can be applied to the heat conductor layer. In principle, a heating device with, for example, two heating circuits is conceivable. However, the principle according to the disclosure is also applicable to heating devices (or heating elements) with more than two heating circuits.

In general, the structuring effort is comparatively low (for example two laser tracks per heating device or heating element). If necessary, structuring is possible with an identical set of parameters for a laser system for both a heating element and a heating element with conductive strips (copper strips).

A temperature in any deflection regions (for example 2 times) is not necessarily significantly increased.

It may be that no additional spraying process is necessary, since a metallic strip (copper strip) can be created from the same material as optional contact pads.

Due to a comparatively short structuring length, masking of the individual tracks (layer portions) themselves can take place (for example instead of subsequent laser structuring). A (possibly more costly) laser process can thus be omitted.

A plurality of heating circuits can be separated from each other by a wire during production, for example.

In the following, the is described on the basis of an exemplary embodiment, which is explained in more detail with reference to the drawings. In the drawings:

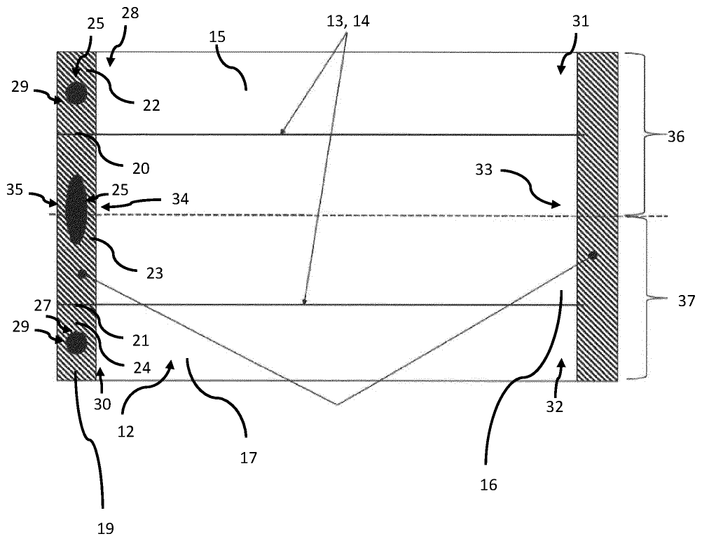

FIG. 1 shows a schematic plan view of an electric heating device according to the invention.

In the following description, the same reference numerals are used for like and similarly acting parts.

FIG. 1 shows a schematic plan view of a heating device according to the invention.

This has a heat conductor layer 12, which can be arranged on a substrate (not shown). The heat conductor layer 12 is divided into a first layer portion 15, a second layer portion 16 and a third layer portion 17 by isolating interruptions 13, 14. The isolating interruptions 13, 14 separate the corresponding layer portions 15, 16 or 16, 17 (completely) from each other. Overall, however, the layer portions 15 to 17 are not completely separated from each other, but are connected (electrically conductively) to each other via a metallic strip 18 (copper strip).

Opposite the strip 18, a second strip (terminal strip) 19 is arranged (in particular metallic, preferably comprising copper). The terminal strip 19 has terminal isolating interruptions 20, 21 which continue the isolating interruptions 13, 14 (respectively). This divides the strip 19 into three strip portions 22, 23, 24. The strip portions 23, 24 are in turn connected to each other with a first pole (in particular positive pole). The strip portion 23 is connected to a second pole (for example negative pole). Contact pads (e.g. comprising copper) 25, 26, 27 are also provided for electrical connection.

A first heating circuit 36 is formed by first layer portion 15 and second layer portion 16. A second heating circuit 37 is formed by third layer portion 17 and second layer portion (common layer portion) 16.

The strip 18 preferably has no interruptions (isolating interruptions).

The strip 18 and/or the strip 19 preferably extend (at least substantially) perpendicular to the layer portions 15, 16, 17.

Specifically, a first end 28 of the first layer portion 15 is connected to a first terminal 29 (or first pole 29, e.g. positive pole, in particular HV+). Similarly, a first end 30 of the third layer portion 17 is connected to the first terminal (pole) 29. A second end 31 of the first layer portion 15 and a second end 32 of the third layer portion 17 are each connected (via the strip 18) to a second end 33 of the second layer portion 16. A first end 34 of the second layer portion 16 is connected to a second terminal 35 (second pole, e.g. negative pole, in particular HV−).

In this sense, a particular terminal (this applies here in particular to the terminal 29) does not have to be formed integrally or coherently.

It should be noted at this juncture that all the parts described above, considered on their own and in any combination, in particular the details shown in the drawings, are claimed as embodiments of the invention. Modifications thereof are possible.

### REFERENCE SIGNS

12 heat conductor layer
13 isolating interruption
14 isolating interruption
15 first layer portion
16 second layer portion
17 third layer portion
18 (connecting) strip
19 (terminal) strip
20 terminal isolating interruption
21 terminal isolating interruption
22 strip portion
23 strip portion
24 strip portion
25 contact pad
26 contact pad
27 contact pad
28 first end of 15
29 first terminal
30 first end of 17
31 second end of 15
32 second end of 17
33 second end of 16
34 first end of 16
35 second terminal
36 first heating circuit
37 second heating circuit

1. Electric heating device, in particular for mobile applications, with:
a substrate and a heat conductor layer formed on the substrate, wherein the heat conductor layer is interrupted by at least a first isolating interruption, wherein the first isolating interruption separates at least a first and a second layer portion of the heat conductor layer from each other, wherein the first layer portion is connected at a first end to a first terminal, and the second layer portion is connected at a first end to a second terminal, wherein the first layer portion is connected at a second end to the second layer portion and is connected via this second layer portion to the second terminal.

2. Electric heating device according to claim 1, wherein the heat conductor layer is interrupted by at least a second isolating interruption, wherein the second isolating interruption separates a third and the second layer portion of the heat conductor layer from each other, wherein the third layer portion is connected at a first end to the first terminal.

3. Electric heating device according to claim 1, wherein the first and second layer portions are at least partially connected to each other by a first separate conductor.

4. Electric heating device according to claim 1, wherein a second separate conductor, is at least partially associated with the first and second terminal.

5. Electric heating device according to claim 1, wherein the first and second terminal are arranged on the same side of the heat conductor layer.

6. Electric heating device according to claim 1, at least one isolating interruption is at least substantially straight.

7. Electric heating device according to claim 1, wherein the heat conductor layer and/or the first and/or the second and/or the third layer portion thereof is/are at least substantially rectangular.

8. Electric heating device according to claim 1, wherein the heat conductor layer covers at least 80% of a substrate surface, and/or an electrically insulating material is arranged in the particular isolating interruption and/or
at least one further insulating layer is formed on the heat conductor layer.

9. Electric heating device according to claim 1, wherein the second layer portion is wider than the first and/or third layer portion.

10. Electric heating device according to claim 1, wherein two or more heating circuits are formed.

11. Electric heating device according to claim 1, wherein at least one isolating interruption passes through the heat conductor layer from a first to a second side thereof.

12. Electric heating device according to claim 1, wherein the electric heating device is a motor vehicle heating device.

13. Vehicle, in particular motor vehicle, comprising an electric heating device according to claim 1.

14. Method for producing an electric heating device according to claim 1, wherein at least one isolating interruption is produced by laser structuring and/or masking of at least one masking portion when applying the heating layer and/or an elongate body which is introduced during production and is later removed again, and/or at least one terminal strip, and/or at least one connection strip, are thermally sprayed and/or are connected to at least one contact pad.

15. Electric heating device according to claim 1, wherein the first terminal is a positive pole and the second terminal is a negative pole.

16. Electric heating device according to claim 3, wherein the first separate conductor is an unstructured conductive strip.

17. Electric heating device according to claim 4, wherein the second separate conductor is a strip divided into at least two separate strip portions by at least one terminal isolating interruption.

18. Electric heating device according to claim 9, wherein the second layer portion is wider than the first and/or third layer portion by a factor of 1.2.

19. Electric heating device according to claim 9, wherein the second layer portion is wider than the first and/or third layer portion by a factor of 1.5.

20. Electric heating device according to claim 1, wherein the heat conductor layer covers at least 85% of a substrate surface.
